(19) United States
(12) Patent Application Publication
(10) Pub. No.: US 2025/0325007 A1
(43) Pub. Date: Oct. 23, 2025

(54) METHOD FOR PRODUCING KOJI-CONTAINING FOOD PRODUCT, AND KOJI-CONTAINING FOOD PRODUCT

(71) Applicant: Hanamaruki Foods Inc., Nagano (JP)

(72) Inventors: Satoru CHIBA, Chuo-ku, Tokyo (JP); Atsushi SHIMIZU, Ohra-gun, Gunma (JP); Kazuhei ISHIKAWA, Ohra-gun, Gunma (JP); Kazuki KAMIKURA, Ohra-gun, Gunma (JP); Nobuki SHIRAI, Ohra-gun, Gunma (JP); Eisaku YAMAMOTO, Ohra-gun, Gunma (JP)

(73) Assignee: Hanamaruki Foods Inc., Nagano (JP)

(21) Appl. No.: 18/868,171

(22) PCT Filed: Jun. 29, 2023
(86) PCT No.: PCT/JP2023/024227

§ 371 Date: Nov. 22, 2024

(30) Foreign Application Priority Data
Jun. 30, 2022 (JP) 2022-105361

(51) Int. Cl. A23L 7/104; A23L 7/10; A23L 27/10; A23L 31/00

(52) U.S. Cl. CPC A23L 7/104; A23L 7/1975; A23L 27/10; A23L 31/00

(57) ABSTRACT

Provided is a method for producing a koji-containing food product, including steps of: fermenting a mixture containing rice, a koji mold, and water; and heating solids contained in the mixture. Also provided is a dried koji-containing food product comprising: a decomposition product of rice fermentation by a koji mold; and a deactivated koji mold.

### TECHNICAL FIELD

The present invention relates to a method for producing a koji-containing food product and a koji-containing food product.

### BACKGROUND ART

Patent Literature 1 discloses a liquid seasoning that has a good balance among umami taste, sweetness, and saltiness while retaining the function of shio-koji (salted malt). The liquid seasoning is obtained by fermenting and maturing a preparation liquid mixture of rice koji (malted rice, called kome-koji), salt, and water at a low temperature and then subjecting it to a solid-liquid separation.

### CITATION LIST

### Patent Literature

Patent Literature 1: Japanese Patent Application Laid-Open Publication No. 2014-050352

### SUMMARY OF INVENTION

### Technical Problem

The liquid seasoning disclosed in Patent Literature 1 is the liquid obtained from the solid-liquid separation of the fermented and matured preparation liquid mixture of rice koji, salt, and water. The solid components obtained from the solid-liquid separation have conventionally been discarded as by-products, and effective utilization of resources has been desired.

It is an object of the present invention to provide a method for producing a koji-containing food product and a koji-containing food product based on the solid components etc., which have been by-products from the production of the above liquid seasoning.

### Solution to Problem

Hence, a first aspect of the present invention provides a method for producing a koji-containing food product, including steps of: fermenting a mixture containing rice, a koji mold, and water; and heating solids contained in the mixture.

A second aspect includes the method of the first aspect, wherein the method includes heating the solids at a temperature greater than or equal to 80° C. and less than or equal to 140° C.

A third aspect includes the method of the first or second aspect, wherein the method includes heating the solids for greater than or equal to 30 minutes and less than or equal to 5 hours.

A fourth aspect includes the method of any one of the first to third aspects, wherein the method includes fermenting the mixture with salt added thereto in the fermenting step. A fifth aspect includes the method of the fourth aspect, wherein the method includes fermenting the mixture at a temperature greater than or equal to 4° C. and less than or equal to 40° C.

A sixth aspect includes the method of the fourth or fifth aspect, wherein the mixture contains rice koji, which is obtained by propagating a koji mold on steamed rice, and water.

A seventh aspect includes the method of any one of the first to sixth aspects, wherein the method includes fermenting the mixture with ethanol further added thereto.

An eighth aspect of the present invention provides a method for producing a koji-containing food product, including a step of heating rice koji, which is obtained by propagating a koji mold on steamed rice.

A ninth aspect includes the method of the eighth aspect, wherein the method includes heating the rice koji at a temperature greater than or equal to 80° C. and less than or equal to 140° C.

A tenth aspect includes the method of the eighth or ninth aspect, wherein the method includes heating the rice koji for greater than or equal to 30 minutes and less than or equal to 5 hours.

An eleventh aspect includes the method of any one of the eighth to tenth aspects, wherein the method includes preheating the rice koji at a temperature greater than or equal to 50° C. and less than or equal to 75° C., prior to the step of heating the rice koji.

A twelfth aspect includes the method of the eleventh aspect, wherein the method includes preheating the rice koji for greater than or equal to 3 hours, prior to the step of heating the rice koji.

A thirteenth aspect of the present invention provides a dried koji-containing food product including: a decomposition product of rice fermentation by a koji mold; and a deactivated koji mold.

A fourteenth aspect includes the koji-containing food product of the thirteenth aspect, wherein the koji-containing food product further contains salt.

A fifteenth aspect includes the koji-containing food product of the thirteenth or fourteenth aspect, wherein the koji-containing food product contains 3-furaldehyde.

A sixteenth aspect includes the koji-containing food product of any one of the thirteenth to fifteenth aspects, wherein a peak A corresponding to a Maillard reaction product of cysteine and glucose is detected in an HPLC analysis and an LC-MS analysis of the koji-containing food product.

A seventeenth aspect includes the koji-containing food product of the sixteenth aspect, wherein the koji-containing food product has: (1) a peak B in a relative retention time range of 1.1 to 1.6 when a retention time of the peak A is taken as 1.0 in chromatography under the following HPLC analysis conditions; (2) a maximum absorption wavelength of the peak B in a range of 279 nm to 289 nm; and (3) a peak in an m/z range of 125.9 to 127.9 in mass spectrometry of the peak B in a positive ion mode of ESI-MS.
(HPLC analysis conditions)
Extract solution: extracted with water four times the weight of an analyte
Mobile phase A: 0.1 wt. % trifluoroacetic acid solution
Mobile phase B: acetonitrile
Isocratic conditions: mobile phase A 95%, mobile phase B 5%
Flow rate: 0.6 mL/min
Column: CAPCELL PAK C18 AQ (available from Osaka Soda Co., Ltd., 4.6 mm×100 mm, 3 μm)
Detection wavelength: 297 nm

### Advantageous Effects of Invention

According to the first aspect of the present invention, it is possible to provide a food product such as a seasoning having excellent taste including richness while maintaining the umami taste of koji, from by-products of the production of liquid shio-koji.

According to the second and third aspects, it is possible to give a good flavor such as deep richness.

According to the fourth and fifth aspects, it is possible to improve the richness and other flavors of foods.

According to the sixth aspect, it is possible to provide a food product with the umami taste of rice koji.

According to the seventh aspect, it is possible to provide a food product that has the flavor of alcohol and also has an improved shelf life due to rot prevention, sterilization, etc.

According to the eighth aspect, it is possible to provide a food product such as a seasoning having excellent taste including richness while maintaining the umami taste of koji, by using a rice koji.

According to the ninth and tenth aspects, it is possible to give a good flavor such as deep richness.

According to the eleventh and twelfth aspects, it is possible to enhance the richness of the koji-containing product by maturing the rice koji (by activating enzymes).

According to the thirteenth aspect, it is possible to provide a food product having good richness and other flavors while maintaining the umami taste of rice koji.

According to the fourteenth aspect, it is possible to provide a food product with more excellent flavors, richness, etc.

According to the fifteenth aspect, it is possible to provide a food product with excellent flavors, richness, etc. due to the progress of a Maillard reaction.

According to the seventeenth and eighteenth aspects, it is possible to provide a food product with excellent flavors, richness, etc. due to the presence of a peak.

### BRIEF DESCRIPTION OF DRAWINGS

FIG. 1 illustrates an example process of producing liquid shio-koji according to a conventional technique.

FIG. 2 illustrates an example process of producing a koji-containing food product according to a first embodiment.

FIG. 3 illustrates absorption spectra of the food product of the present invention, a sample of the food product before being heated, and the like.

FIGS. 4A and 4B illustrate FT-IR spectra, where FIG. 4A illustrates an FT-IR spectrum of the food product of the present invention, and FIG. 4B illustrates an FT-IR spectrum of a sample of the food product before being heated and dried.

FIGS. 5A and 5B illustrate graphs showing some results of sensory evaluation of the food product of the present invention as used in butter cookies, where FIG. 5A is a graph showing temporal changes in taste strength, and FIG. 5B is a graph showing the spread of taste in the mouth.

FIG. 6 illustrates an example process of producing a koji-containing food product according to second and third embodiments.

FIG. 7 illustrates a graph showing results of gas chromatography-mass spectrometry of the koji-containing food product of the present invention and the like.

FIG. 8 illustrates an HPLC chromatograph of the koji-containing food product of the present invention.

FIGS. 9A and 9B illustrate HPLC analysis results, where FIG. 9A is a graph of the koji-containing food product, and FIG. 9B is a graph of a Maillard reaction product of cysteine and glucose.

FIG. 10 illustrates UV spectra of samples.

FIGS. 11A and 11B illustrate mass spectra measured in the positive ion mode of ESI-MS, where FIG. 11A illustrates a mass spectrum of the koji-containing food product of the present invention, and FIG. 11B illustrates a mass spectrum of a Maillard reaction product of cysteine and glucose.

FIG. 12 illustrates a mass spectrum of the koji-containing food product of the first embodiment measured in the positive ion mode of ESI-MS.

### DESCRIPTION OF EMBODIMENTS

Exemplary embodiments of the present invention will be described below. The following descriptions and examples are intended to illustrate exemplary embodiments and are not intended to limit the scope of the present invention.

In the present disclosure, unless otherwise indicated, the ranges of values written in the forms of “greater than or equal to . . . and less than or equal to . . . ”, “(from) . . . to . . . ”, etc. include the upper and lower limits specified.

A method for producing a koji-containing food product according to a first embodiment includes a step of fermenting a mixture containing rice, a koji mold, and water, and a step of heating solids contained in the mixture.

First, the koji-containing food product produced by the first embodiment is described.

The koji-containing food product produced by the present embodiment can give an umami taste, mainly deep richness, to the foods made by using it. This is presumably attributable to the following mechanisms.

As described below, adding koji to rice and fermenting it causes sugars, proteins, and other substances in the rice to be decomposed by various degrading enzymes, resulting in producing reducing sugars, amino acids, peptides, and other substances. Conventionally, food products obtained by the fermentation have not been further heated. In the present embodiment, in contrast, the solids containing these decomposed products, especially the solids resulting from solid-liquid separation, are heated to cause a Maillard reaction to generate melanoidin, which gives richness (koku) to the taste and also makes the taste persistent.

It is also known that fermentation of koji produces aromatic components such as amines and aldehydes, which give a rich aroma to foods.

Furthermore, the use of rice gives a rich texture, by virtue of dietary fiber derived from the rice as well as sugars and other substances produced by the decomposition of the rice.

The richness in terms of these taste, aroma, and texture is believed to provide different effects depending on the food ingredients combined, resulting in the exhibition of richness, umami taste, and other attributes.

The method for producing a koji-containing food product according to the first embodiment is now described in detail.

First, a mixture containing rice, a koji mold, and water is fermented.

There are no limitations to the type of food product obtained as long as it is obtained by fermenting rice, a koji mold, and water. Typically, in the present embodiment, salt is further added to produce shio-koji. However, it is also possible to produce amazake (sweet fermented rice drink) without adding salt, to produce sake by adding yeast, and to produce mirin (sweet sake) by adding alcohol.

The following describes the case of producing shio-koji.

Usually, a koji mold is added to rice to produce what is called kome-koji (rice koji).

The rice koji used in the present embodiment may be prepared according to an ordinary rice koji production method. Specifically, the rice koji may be obtained by sprinkling a koji mold (also called tane-koji (seed koji)) on steamed rice, which is obtained by steaming rice, and allowing the koji mold to propagate under optimal conditions for it. The koji mold may be propagated by culturing at 25 to 40° C. for 2 to 4 days using an automatic fermenter (e.g., HK-60, available from Yaegaki Food & System, Inc.). The rice koji used in the present invention may be a commercial product.

The rice used is e.g., non-glutinous rice, glutinous rice, or brewing rice, preferably polished (white) rice. The non-glutinous rice may either be japonica rice or indica rice. The rice may be washed as necessary, soaked in water, and drained as necessary.

The koji mold may be any koji mold that is used for ordinary koji production. Suitable examples include genus aspergillus (Asperugillus), such as Aspergillus oryzae and Asperugillus sojae. The koji mold used in the present invention may be a commercial product sold as seed koji or may be a cultured mold. The koji mold may be granular or powdery. The koji mold used in the present embodiment preferably has high saccharification power or high protease production ability. Specific examples of such koji mold include a koji mold for miso, a koji mold for rice koji, and a koji mold for soy sauce, among which the koji mold for rice koji and the koji mold for miso are more preferred, with the koji mold for miso being further preferred. The koji mold may be of a single kind or a mixture of different kinds.

The mixture containing the rice, koji mold, and water for fermentation is usually in the form of water containing the rice and other ingredients. When producing shio-koji by fermentation, the rice koji obtained above is mixed with salt and water. These may be fed and mixed simultaneously or sequentially.

The content of rice koji in the mixture is desirably greater than or equal to 30 wt. % and less than or equal to 70 wt. %, preferably greater than or equal to 35 wt. % and less than or equal to 60 wt. %, more preferably greater than or equal to 40 wt. % and less than or equal to 55 wt. %, and even more preferably greater than or equal to 45 wt. % and less than or equal to 50 wt. %.

The content of salt in the mixture is desirably greater than or equal to 2 wt. % and less than or equal to 20 wt. %, preferably greater than or equal to 3 wt. % and less than or equal to 18 wt. %, more preferably greater than or equal to 4 wt. % and less than or equal to 16 wt. %, and even more preferably greater than or equal to 5 wt. % and less than or equal to 15 wt. %. The salt can inhibit the growth of microorganisms in the mixture. Too little salt tends to cause the growth of microorganisms.

The mixture containing the rice, koji mold, and water is fermented. The mixture is preferably fermented and matured at a temperature at which enzymes derived from the koji mold contained in the mixture are not inactivated (deactivated) by the fermentation. The enzymes derived from the koji mold refer to enzymes produced by the koji mold, which include, e.g., amylase, protease, lipase, and cellulase. These enzymes are heat sensitive, and protease, in particular, is inactivated by fermentation at temperatures at or above 60° C.

In a preferred embodiment, the fermentation temperature is desirably 4 to 40° C., preferably 20 to 38° C., more preferably 25 to 35° C., and even more preferably 28 to 32° C. At these temperatures, the enzymes derived from the koji mold will not be inactivated.

During the fermentation, not only the fermentation by the koji mold occurs, but also starch, protein, lipids, and other substances contained in the rice are usually decomposed by the enzymes derived from the koji mold. This decomposition may often be called saccharification. The fermented mixture (fermented and matured product) is generally called “shio-koji (salted malt)” and may be sold commercially in this state.

According to preferred embodiments, the fermentation is desirably carried out until a Brix value of the fermented mixture (fermented and matured product) increases by 4% or more, preferably by 6% or more, and more preferably by 9% or more, relative to a Brix value on the first day of the fermentation. The Brix value refers to a value measured using a sugar refractometer and varies with an increase or decrease in sucrose, salt, various amino acids, glucose, maltose, and other ingredients. Thus, the Brix value varies depending on the composition of raw materials in the preparation liquid. In the case of, e.g., the preparation liquid mixture of 50 wt. % rice koji, 13 wt. % salt, and 37 wt. % water, the fermentation is desirably carried out until the Brix value of the fermented mixture becomes 37% or more, preferably 39% or more, and more preferably 41% or more. The Brix value can be measured using any technique known in the art. For example, it can be measured using a commercial hand-held refractometer or a commercial digital refractometer. In general, measuring the Brix value is simpler than measuring the concentration of direct sugar.

According to preferred embodiments, the fermentation is desirably carried out until the concentration of direct sugar of the fermented liquid mixture increases by 8% or more, preferably by 12% or more, and more preferably 18% or more, relative to the concentration of direct sugar on the first day of the fermentation. The direct sugar as referred to herein means direct reducing sugar, and the concentration of direct sugar varies depending on the composition of raw materials in the preparation liquid. For example, in the case of the mixture of 50 wt. % rice koji, 13 wt. % salt, and 37 wt. % water, the fermentation is desirably carried out until the concentration of direct sugar of the fermented preparation liquid becomes 16% or more, preferably 20% or more, and more preferably 26% or more. The concentration of direct sugar can be measured using any technique known in the art. For example, it can be measured using a modified Somogyi method (Nippon Nogeikagaku Kaishi 28(3) 171-174 (1954)) or a method stipulated by Japan Agricultural Standards for soy-source.

According to more preferred embodiments, the fermentation is desirably carried out until the Brix value and the concentration of direct sugar of the fermented liquid mixture (fermented and matured product) increase by 4% or more and by 8% or more, respectively, preferably by 6% or more and by 12% or more, respectively, and more preferably by 9% or more and by 18% or more, respectively, relative to the respective values on the first day of the fermentation. Such increases in the Brix value and the concentration of direct sugar of the fermented mixture (fermented and matured product) by 4% or more and by 8% or more, respectively, relative to the respective values on the first day of the fermentation provide a better balance among the umami taste, sweetness, and saltiness.

According to one embodiment of the present invention, in the case of, e.g., the preparation liquid mixture of 50 wt. % rice koji, 13 wt. % salt, and 37 wt. % water, the fermentation is preferably carried out until the Brix value and the concentration of direct sugar of the fermented liquid mixture (fermented and matured product) become 37% or more and 16% or more, respectively, more preferably 39% or more and 20% or more, respectively, and even more preferably 41% or more and 26% or more, respectively.

According to preferred embodiments, the fermentation is desirably carried out at low temperatures for 1 to 60 days, preferably for 2 to 30 days, more preferably for 3 to 21 days, even more preferably for 4 to 14 days, yet even more preferably for 6 to 13 days, especially preferably for 8 to 12 days, and most preferably for 10 days. The lower the temperature, the longer the fermentation period due to reduced activity of enzymes derived from the koji mold. Thus, according to more preferred embodiments, the fermentation is desirably carried out at 20 to 38° C. for 3 to 21 days, more preferably for 4 to 14 days, even more preferably for 6 to 13 days, especially preferably for 8 to 12 days, and most preferably for 10 days.

According to even more preferred embodiments of the present invention, the fermentation is carried out at 20 to 38° C. for 3 to 21 days until the Brix value and the concentration of direct sugar of the fermented liquid mixture (fermented and matured product) increase by 4% or more and by 8% or more, respectively, relative to the respective values on the first day of the fermentation.

In a step after the fermentation, the solids in the mixture are heated.

In preferred embodiments, the solids and liquid are separated using a solid-liquid separation method, and the resulting solids are heated. The solid-liquid separation method is not limited, and may be any method usually used for mirin or soy sauce. Example solid-liquid separation methods include press filtration using a press filter, pressing using filter cloth, and solid-liquid separation using a centrifuge, among which the press filtration is preferable.

The filtrate resulting from the solid-liquid separation can be directly used as a liquid seasoning (liquid shio-koji) of conventional art.

The solid components resulting from the solid-liquid separation are pressed lees, which, as mentioned earlier, have conventionally been discarded as by-products. In the present embodiment, the pressed lees are crushed by a mincer or other means into a powder of about 5 mm, which is then heated.

In order to dry the powder in this heating and to give richness, umami taste, and other attributes to the resulting food product, the heating temperature is preferably greater than or equal to 80° C. and less than or equal to 140° C., more preferably greater than or equal to 100° C. and less than or equal to 120° C. The heating temperature is preferably greater than or equal to 30 minutes and less than or equal to 5 hours, more preferably greater than or equal to 30 minutes and less than or equal to 3 hours, and even more preferably greater than or equal to 1 hour. At temperatures around and below 80° C., in particular, the heating is insufficient. On the other hand, at temperatures around and above 140° C., the powder tends to have almost burned parts, making it undesirable as a food product. During the aforementioned fermentation, the koji mold is being killed, which is further accelerated by the optional addition of ethanol (spirits) as described below. In general, the koji mold is completely killed during heating of the pressed lees and is inactivated after drying.

When using the powder in dishes that involve pickling or marinating, it is preferable that the koji mold has all been killed, as the living koji mold will decompose the meat, fish and other ingredients. However, if the dishes are to be cooked immediately after the addition of the powder or if ingredients that are immune to enzymatic decomposition are used, some koji mold may remain alive.

If it is necessary to confirm the inactivation of the koji mold, it can be confirmed by, for example, culturing on a potato dextrose agar medium. Alternatively, using multiple dyes in a fluorescent staining method can produce an image in which molds with respiratory activity are stained and an image in which all molds are stained. By superimposing the obtained two images of different colors, the presence or absence of molds without respiratory activity (dead molds) and proportions of their presence can be confirmed. Further, whether or not any mold that appears in the images is the control koji mold can be confirmed by, for example, examining the DNA sequence of the mold.

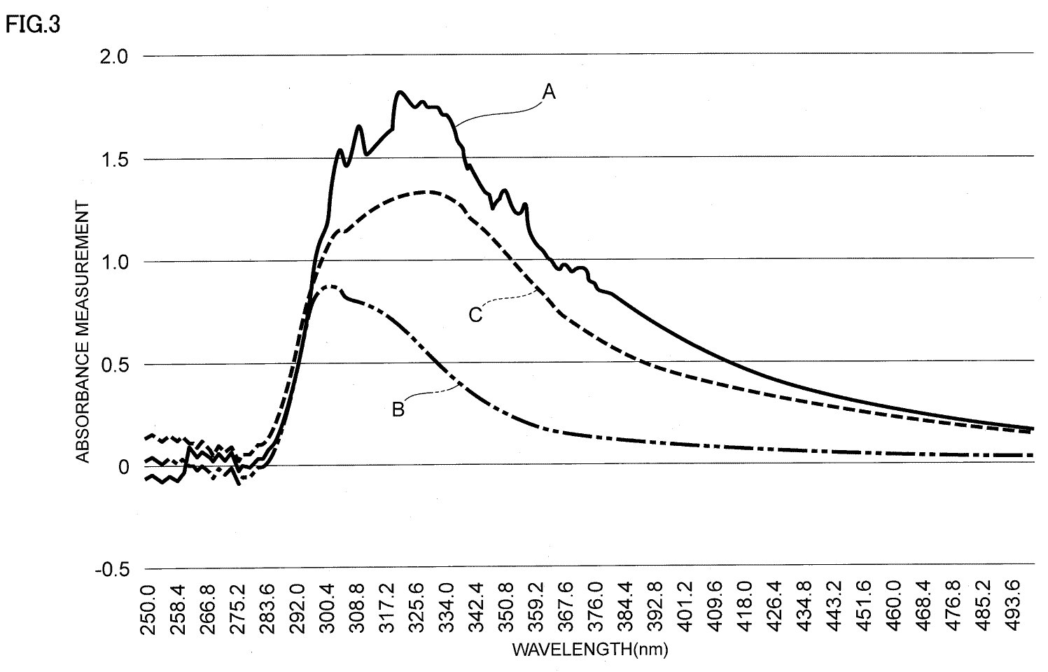

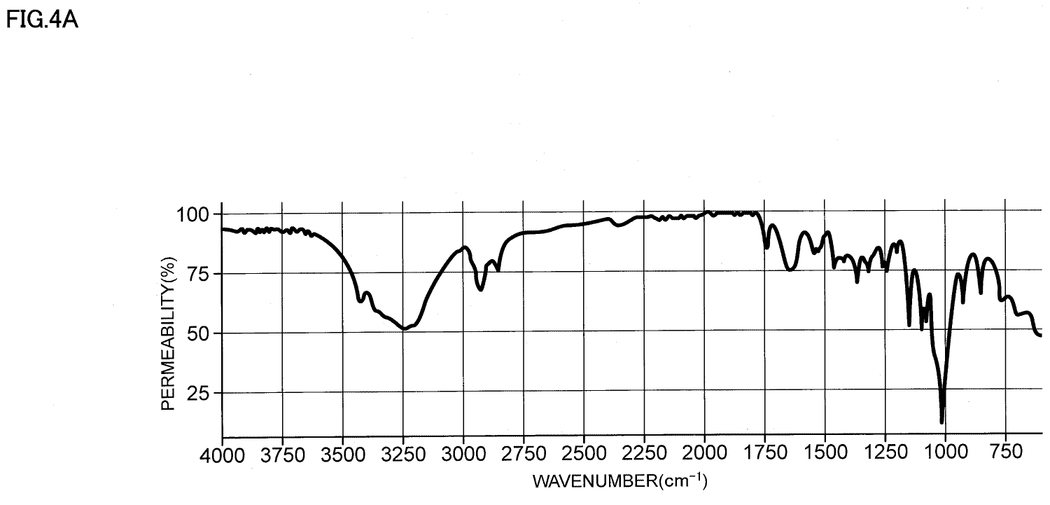

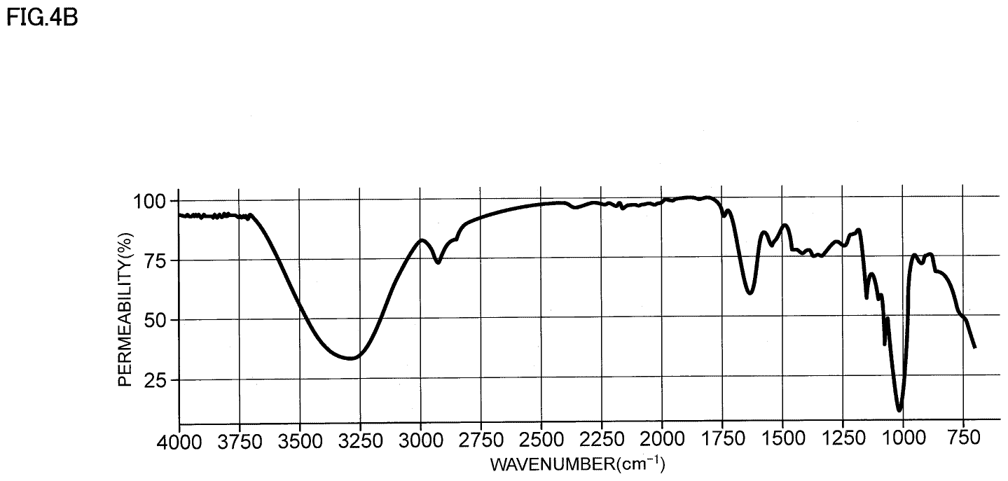

After heating, the powder preferably changes to a darker color, such as light brown, than before drying. This is believed to be due to the fact that, as mentioned earlier, reducing sugars, amino acids, peptides, and other substances are produced by the decomposition of sugars, proteins, and other substances in the rice by various degrading enzymes during the fermentation, and the Maillard reaction caused by heating of these reducing sugars, amino acids, peptides, and other substances generates a reaction product, or melanoidin. Although it is difficult to confirm the generation of melanoidin as it is not a single substance, in addition to the above color change, additional evidence for the presence of melanoidin is that the absorption spectrum in Example 3 (chart A in FIG. 3) has a longer peak absorption wavelength than before heating and has an absorption peak at about 325 nm, as with Reference Example C where lysine and galactose were mixed and heated, and that the FT-IR spectrum in Example 4 (FIG. 4A) has an increased number of peaks in the fingerprint region (1500 cm⁻¹ to 650 cm⁻¹).

The resulting powder is classified by any means usually used in the food industry, such as sieve, to obtain the koji-containing food product of the present embodiment in the form of a powder of desired size. The smaller the powder, the more palatable it is. This food product is in a dried state and contains decomposition products of rice fermentation by the koji mold, as well as the salt and deactivated koji mold, as described above.

By nature of its composition, this food product may be eaten as it is, but is especially preferred for use as a seasoning for other dishes and confectionery. Non-limiting examples of dishes to which this food product may be added include the following:

Prepared foods: hamburgers, curry, cod roe, Japanese omelette, cream stew, etc.

Sauces and soups: consommé soup, meat sauce, white sauce, cheese sauce, miso-ramen soup, miso soup, anchovy sauce, etc.

Confectionery: ice cream, cookies, milk chocolate, white chocolate, potato chips, scones, etc.

The amount to be added to a dish, etc. depends on the dish, etc. for which the food product is used, but is preferably greater than or equal to 0.1 wt. % and less than or equal to 5 wt. %, for example. The variety of resulting taste depends on factors such as the dish for which the food product is used, the amount used, and the environment in which the food product is used, but may include milkiness, cheesiness, brothy taste, spiciness, acidity, etc. Other effects on the taste of dishes etc. may also be obtained, such as reducing the sharpness of salt, masking the smell of livestock meat, providing the persistent spiciness of chili peppers, etc.

It is also preferred to add ethanol (spirits) to the food product of the present embodiment, from the viewpoint of improving the flavor and extending the shelf life by sterilization. The addition of ethanol may be made at any point, such as during the step of fermenting the rice or during the step of heating the pressed lees. In some cases, yeast may be added to the mixture prior to fermentation to produce the ethanol in the mixture. The amount of ethanol relative to the koji-containing food product of the present embodiment is preferably greater than or equal to 0.5 wt. % and less than or equal to 10 wt. %, more preferably greater than or equal to 1 wt. % and less than or equal to 6 wt. %, and even more preferably greater than or equal to 2 wt. % and less than or equal to 5 wt. %. A too low concentration of ethanol tends to provide no effects of the addition, and a too high concentration of ethanol tends to make the alcohol smell and taste more pronounced, both of which are undesirable.

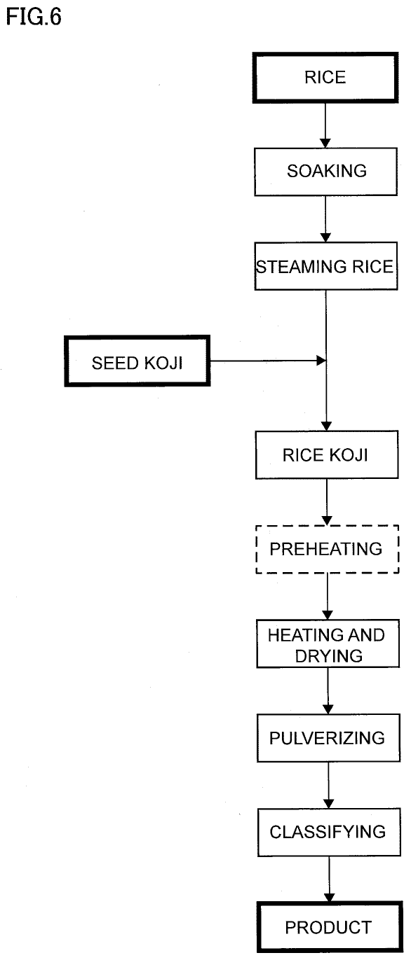

Referring now to FIG. 6, methods for producing a koji-containing food product according to second and third embodiments are described.

The method for producing a koji-containing food product according to the second embodiment includes a step of heating rice koji, which is obtained by propagating a koji mold on steamed rice. The method for producing a koji-containing food product according to the third embodiment includes preheating the rice koji at a temperature of greater than or equal to 50° C. and less than or equal to 75° C., prior to heating the rice koji as in the method for producing a koji-containing food product according to the above second embodiment. In FIG. 6, the second embodiment does not perform the “preheating” step in the figure, while the third embodiment performs the “preheating” step prior to the “heating and drying” step.

The koji-containing food products produced by the second and third embodiments (hereinafter respectively abbreviated as the “koji-containing food product of the second embodiment” and the “koji-containing food product of the third embodiment”) differ from the koji-containing food product produced by the first embodiment in terms of how they are produced. In particular, the second and third embodiments do not require the step of fermenting the mixture containing rice, koji mold, and water. Nevertheless, the koji-containing food products of the second and third embodiments each can give an umami taste, mainly deep richness, to the foods made by using it, as with the koji-containing food product of the first embodiment. This is presumably attributable to the following mechanisms.

Sugars, proteins, and other substances are present in rice. These compounds are decomposed by various degrading enzymes during propagating a koji mold on steamed rice to obtain a rice koji and during heating the resulting rice koji, whereby reducing sugars, amino acids, peptides, and other substances are produced. As mentioned earlier, food products obtained by the fermentation have not conventionally been further heated. In the second and third embodiments, too, these decomposed products are contained in the rice koji, and heating the rice koji causes a Maillard reaction to generate melanoidin, which gives richness to the taste and also makes the taste persistent.

In the third embodiment, the rice koji is preheated before being heated, which can mature the rice koji and activate the enzymes contained in it, enhancing the richness of the koji-containing food product.

Additionally, in the second and third embodiments, too, the use of rice gives a rich texture by virtue of dietary fiber derived from the rice as well as sugars and other substances produced by the decomposition of the rice. The richness in terms of these taste and texture is believed to provide different effects depending on the food ingredients combined, resulting in the exhibition of richness, umami taste, and other attributes.

The method for producing a koji-containing food product according to the second embodiment is now described in detail.

A rice koji obtained by propagating a koji mold on steamed rice is heated.

The rice koji may be produced according to a usual rice koji production method. Specifically, the rice koji may be obtained by sprinkling a koji mold (also called seed-koji) on steamed rice, which is obtained by steaming rice, and allowing the koji mold to propagate under optimal conditions for it. The koji mold may be propagated by culturing at 25 to 40° C. for 2 to 4 days using an automatic fermenter (e.g., HK-60, available from Yaegaki Food & System, Inc.). The rice koji used may be a commercial product.

Rice, koji mold, and other ingredients for the rice koji may be the same as those described in connection with the koji-containing food product of the first embodiment.

Then, the rice koji is heated. In order to dry the entire rice koji in this heating and to give richness, umami taste, flavor, and other attributes to the resulting food product, the heating temperature is preferably greater than or equal to 80° C. and less than or equal to 140° C., more preferably greater than or equal to 100° C. and less than or equal to 120° C. The heating temperature is preferably greater than or equal to 30 minutes and less than or equal to 5 hours, more preferably greater than or equal to 30 minutes and less than or equal to 3 hours, and even more preferably greater than or equal to 1 hour. At temperatures around and below 80° C., in particular, the heating tends to be insufficient. On the other hand, at temperatures around and above 140° C., the rice koji tends to have almost burned parts, making it undesirable as a food product. The koji mold is being killed during this heating and, in general, it is completely inactivated after drying.

When using the rice koji in dishes that involve pickling or marinating, it is preferable that the koji mold has all been killed, as the living koji mold will decompose the meat, fish and other ingredients. However, if the dishes are to be cooked immediately after the addition of the rice koji or if ingredients that are immune to enzymatic decomposition are used, some koji mold may remain alive.

Confirmation of the inactivation of the koji mold, the presence or absence of dead molds and proportions of their presence, and whether or not any mold is the koji mold can be done in the same manner as in the first embodiment described above.

After heating, the rice koji preferably changes to a darker color, such as light brown, than before drying, as with the powder obtained in the first embodiment. This is believed to be due to the fact that, as mentioned earlier, reducing sugars, amino acids, peptides, and other substances are produced by the decomposition of sugars, proteins, and other substances in the rice by various degrading enzymes during the formation of rice koji, and these reducing sugars, amino acids, peptides, and other substances are further decomposed during heating and also the Maillard reaction caused by the heating generates the reaction product, melanoidin. Although it is difficult to confirm the generation of melanoidin as it is not a single substance, in addition to the above color change, additional evidence for the presence of melanoidin is that the generation of some Maillard reaction products can be observed, as shown in Example 13.

The resulting powder is classified by any means usually used in the food industry, such as a sieve, to obtain the koji-containing food product of the second embodiment in the form of a powder of desired size. The smaller the powder, the more palatable it is. This food product is in a dried state and contains decomposition products of rice fermentation by the koji mold, as well as the deactivated koji mold, as described above.

The method for producing a koji-containing food product according to the third embodiment is now described. In the third embodiment, the “preheating” step, enclosed by the dotted line in FIG. 6, is performed prior to the “heating and drying” step.

Specifically, the rice koji obtained by propagating a koji mold on steamed rice is preheated before being heated. The preheating temperatures is preferably greater than or equal to 50° C. and less than or equal to 75° C., more preferably greater than or equal to 55° C. and less than or equal to 70° C. The preheating time is preferably greater than or equal to 3 hours, more preferably greater than or equal to 4 hours. While there is no theoretical upper limit to the preheating time, one day or less is preferred for practical purposes, because prolonged preheating will provide no additional effects. Selecting the temperature and time from these ranges allows the koji mold-derived enzymes in the rice koji to be matured and activated at temperatures at which the enzymes are not inactivated (deactivated). The maturation and activation can enhance the richness of the resulting koji-containing food product, compared to when the rice koji is not preheated (i.e., compared to the koji-containing food product of the second embodiment).

In the third embodiment, the rice koji used and the subsequent steps after the preheating are the same as those in the method for producing a koji-containing food product according to the second embodiment described above. After preheating the rice koji, the heating and drying, pulverizing, and classifying steps are performed as in the second embodiment, resulting in the koji-containing food product of the third embodiment in the form of a powder (see FIG. 6).

The resulting koji-containing food product of the third embodiment is in a dried state and contains decomposition products of rice fermentation by the koji mold, as well as the deactivated koji mold, similarly to the koji-containing food product of the second embodiment.

By nature of their compositions, the koji-containing food products of the second and third embodiments may be eaten as they are, but are especially preferred for use as a seasoning for other dishes and confectionery. Non-limiting examples of dishes to which these food products may be added include those listed in connection with the koji-containing food product of the first embodiment.

The amount to be added to a dish, etc. depends on the dish, etc. for which the food products are used, but is preferably greater than or equal to 0.1 wt. % and less than or equal to 5 wt. %, for example. The variety of resulting taste depends on factors such as the dish for which the food products are used, the amount used, and the environment in which the food products are used, but may include milkiness, cheesiness, brothy taste, spiciness, acidity, etc. Other effects on the taste of dishes etc. may also be obtained, such as reducing the sharpness of salt, masking the smell of livestock meat, providing the persistent spiciness of chili peppers, etc.

It is also preferred to add ethanol (spirits) to the koji-containing food products of the second and third embodiments, from the viewpoint of improving the flavor and extending the shelf life by sterilization. Salt may also be added. The amount of ethanol and salt to be added and the effects of their addition are the same as for the koji-containing food product of the first embodiment.

Each of the koji-containing food products of the first to third embodiments is a dried food product containing decomposition products of rice fermentation by the koji mold, as well as the deactivated koji mold. These food products contain Maillard reaction products, which can enhance richness, umami taste, and other attributes of other foods.

In one preferred example, and not by way of limitation, each koji-containing food product contains 3-furaldehyde, which is one of the intermediate products of the Maillard reaction, as described in Example 12. The content of 3-furaldehyde relative to the entire koji-containing food product is preferably greater than or equal to 7 ng/g, especially preferably greater than or equal to 10 ng/g, from the viewpoint of enhancing richness, umami taste, and other attributes of other foods.

Preferably, and not by way of limitation, each koji-containing food product has a peak A corresponding to a Maillard reaction product of cysteine and glucose detected in HPLC and LC-MS analyses, as described in Example 13. The compound of the peak A has a maximum absorption wavelength in the UV spectrum in the range of 297 nm±5 nm, especially in the range of 297±3 nm, and has a peak in the m/z range of 125.9 to 127.9 in mass spectrometry in the positive ion mode of ESI-MS.

Preferably, and not by way of limitation, each koji-containing food product has:
(1) a peak B in a relative retention time range of 1.1 to 1.6 when the retention time of the peak A is taken as 1.0 in chromatography under HPLC analysis conditions described in Example 13;
(2) a maximum absorption wavelength of the peak B in a range of 279 nm to 289 nm; and
(3) a peak in the m/z range of 125.9 to 127.9 in mass spectrometry of the peak B in the positive ion mode of ESI-MS.

### EXAMPLES

Embodiments of the present invention are detailed below with reference to Examples, though embodiments of the present invention are in no way limited to these Examples. Unless otherwise indicated, the amounts used indicated by the words or symbols such as “parts”, “%” below are by weight.

### Example 1

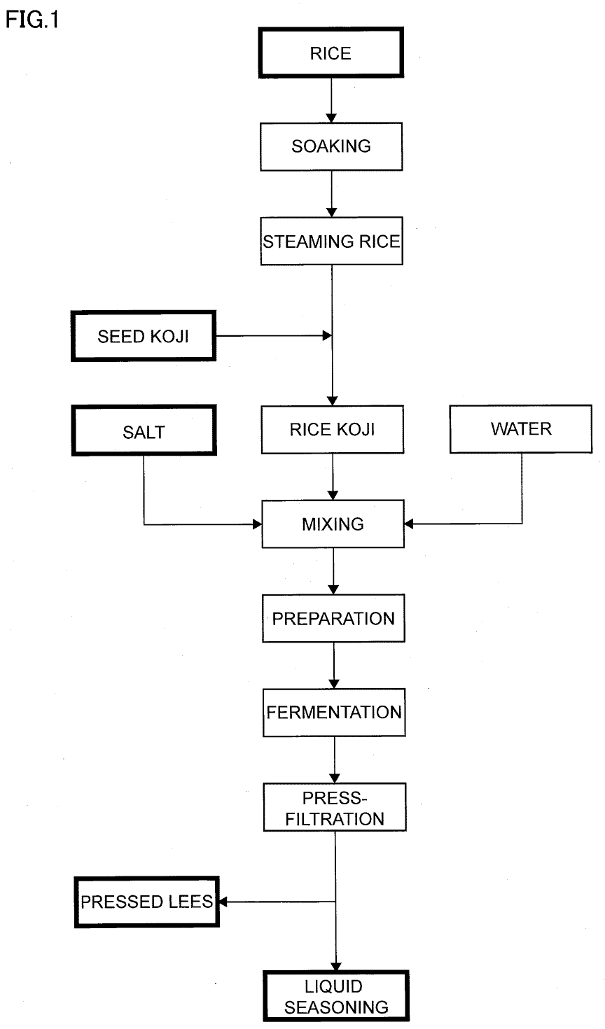

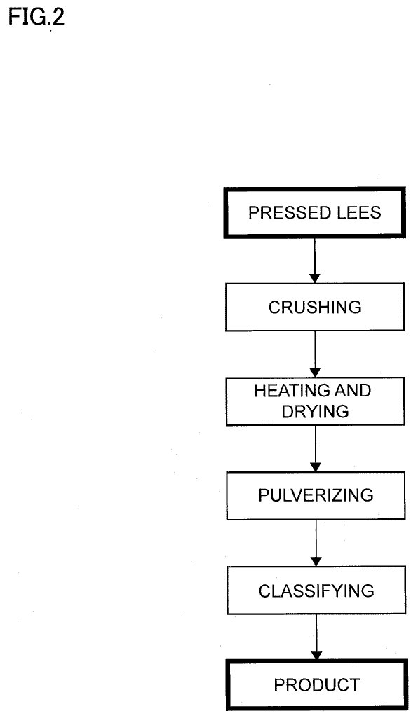

Rice koji and a liquid seasoning were prepared according to the steps shown in FIG. 1, and a koji-containing food product of the first embodiment was prepared according to the steps shown in FIG. 2.

### (1) Preparation of Rice Koji

Rice was soaked in water 1.2 times the volume of rice for 12 hours and then drained for 2 hours, followed by steaming the drained rice for 45 minutes using a steamer (available from Hanyuda Co., Ltd.), resulting in steamed rice. The steamed rice was cooled to 30° C., and a seed koji (seed koji for miso, obtained from Higuchi Matsunosuke Shoten Co., Ltd.) was sprinkled and mixed several times (a step known as tanekiri) to give a content of 0.3 g of seed koji per 1 kg of steamed rice (steamed rice: seed koji=1000:0.3). The rice mixed with the seed koji was cultivated with occasional stirring for 42 hours at 35° C. using an automatic fermenter (HK-60, available from Yaegaki Food & System, Inc.), resulting in rice koji.

### (2) Preparation of Liquid Seasoning

The resulting 50 kg of rice koji was mixed with 13 kg of salt (crude salt) and 37 L of water to produce a preparation liquid. The preparation liquid was fermented and matured at 30° C. for 10 days, resulting in a matured product. The resulting matured product was press-filtered using a press-filtration machine (press-filtration machine for laboratories, available from NSK Engineering Co., Ltd.) to obtain the filtrate as a liquid seasoning and also obtain the pressed lees as solid components.

### (3) Preparation of Koji-Containing Food Product

The resulting pressed lees were coarsely crushed by a chopper (model: 10B, available from Zenmigo Co., Ltd.), followed by heating at 105° C. for 2 hours using a three-stage band dryer to dry them. The resulting lees were pulverized by a hammer mill and then sieved using a vibrating sieve machine (model: TMC-70-2S, available from Tokuju Co., Ltd.) to obtain a powder passing through a 40-mesh screen as the desired koji-containing food product. From 100 kg of the pressed lees, 65 kg of the koji-containing food product of the first embodiment was obtained.

The koji-containing food product obtained in the above process (3) was used throughout Examples 2 to 8 below.

### Example 2

The free amino acid and sugar compositions of the obtained koji-containing food product were determined by the following methods.

### Amino Acid Analysis

About 1 g or 2 g of the koji-containing food product was weighed out accurately and then extracted with 50 mL of 75% ethanol at 80° C. for 30 minutes by refluxing, followed by removing impurities by filtration to fix the volume at 100 mL. A 4 mL aliquot of the extract was taken and concentrated to dryness in an evaporator (rotary evaporator K-1000, available from Tokyo Rikakikai co., ltd.), followed by completely dissolving it in 8 mL of citric acid buffer (pH 2.2). The solution was then filtered through a 0.45-μm membrane filter (available from Toyo Roshi Kaisha, Ltd. under the product name “DISMIC 26CS045AN”) to obtain a filtrate, which was then analyzed for amino acid by high-performance liquid chromatography based on o-phthalaldehyde (OPA) post-column derivatization/fluorescence detection, using an LC-VP amino acid analysis system (available from Shimadzu Corporation).

### Reducing Sugar Analysis

To 10 g of the koji-containing food product, 490 mL of water was added, followed by stirring and mixing. Then, 5 mL of this mixed solution was taken into a beaker and 95 mL of water was added thereto, followed by stirring and mixing again. The resulting solution was filtered through a 0.45-μm membrane filter (available from Toyo Roshi Kaisha, Ltd. under the product name “DISMIC 26CS045AN”), and the filtrate was analyzed for reducing sugars using a high-performance liquid chromatography reducing sugar analysis system (available from Shimadzu Corporation). The analysis results are shown in Tables 1 and 2, respectively, along with the results for a sample in the condition prior to heating and drying in the above step (3) and for a commercially available liquid shio-koji. The nutrition facts (theoretical values per 100 g) of the resulting koji-containing food product as a food product are shown in Table 3.

TABLE 1

| | | |
|---|---|---|
| Free amino acid | Koji-containing | Control examples |

| composition | food product | Prior | Liquid |
|---|---|---|---|
| (mg/100 g) | (Example) | to drying | shio-koji |
| Arg | 22 | 64 | 80 |
| Lys | 7 | 34 | 45 |
| His | 3 | 11 | 14 |
| Phe | 14 | 50 | 47 |
| Tyr | 19 | 53 | 50 |
| Leu | 21 | 67 | 88 |
| Ile | 8 | 32 | 34 |
| Met | 4 | 15 | 13 |
| Val | 13 | 41 | 44 |
| Cys | — | — | — |
| Ala | 22 | 44 | 62 |
| Gly | 8 | 16 | 16 |
| Pro | 10 | 15 | 7 |
| Glu | 24 | 57 | 108 |
| Ser | 13 | 28 | 32 |
| Thr | 8 | 22 | 64 |
| Asp | 13 | 38 | 42 |

TABLE 2

| | |
|---|---|
| Koji-containing | Control examples |

| | food product | Prior | Liquid |
|---|---|---|---|
| | (Example) | to drying | shio koji |
| Maltose | 398 | 381 | 134 |
| Fructose | 137 | 98 | 82 |
| Galactose | 48 | 156 | 113 |
| Isomaltose | 921 | 1,647 | 2035 |
| glucose | 21,399 | 26,251 | 26,671 |
| Total | 22,903 | 28,533 | 29,035 |

TABLE 3
Nutrition facts (per 100 g)

| | | |
|---|---|---|
| Calories | 359 | kcal |
| Water | 1.8 | g |
| Protein | 11.1 | g |
| Lipid | 3.9 | g |
| Carbohydrates | 69.6 | g |
| Ash | 13.3 | g |
| Sodium chloride | 12.4 | g |
| equivalent | | |

The symbol “-” in Table 1 indicates below limit of detection. From Table 1, it can be seen that the free amino acids are reduced compared to the sample prior to the drying step, but no significant specificity is observed for each amino acid.

From Table 2, it can be seen that all reducing sugars except for fructose are reduced compared to the sample prior to the drying step. In addition, from Tables 1 and 2, it can be inferred that melanoidin is generated by the Maillard reaction between the amino acids and reducing sugars upon heating.

### Example 3

The respective absorption spectra of the resulting koji-containing food product and the sample prior to the heating and drying step were analyzed. Specifically, distilled water of 10 times the volume was added to each sample, followed by pulverizing it into fine particles using a homogenizer (US-150T, available from Nissei Corporation). The resulting solution was centrifuged at 3000 rpm for 20 minutes using a centrifuge (table-top refrigerated centrifuge H-30R, available from Kokusan Corporation). The resulting supernatant liquid was filtered through a 0.45-μm membrane filter (available from Toyo Roshi Kaisha, Ltd. under the product name “DISMIC 26CS045AN”), and the filtrate was subjected to absorbance measurements at each wavelength using a spectrophotometer (UV-1280 UV-visible spectrophotometer, available from Shimadzu Corporation).

The results are shown in the absorption spectra of FIG. 3. In the figure, chart A represents the sample of koji-containing food product (Example) and chart B represents the sample prior to the heating and drying step.

As a reference example, a sample of aqueous solution containing equal amounts of lysine and galactose was heated at 105° C. for 2 hours, and then the mixture in the solution was pulverized into fine particles, centrifuged, and filtered for measurement in the same manner as above. The results are shown in FIG. 3 as Reference Example C.

It can be seen from FIG. 3 that the peak of the absorption spectrum of the sample B prior to heating was around 300 nm, but the peak of the koji-containing food product A of Example shifted to a longer wavelength around 325 nm due to heating. Reference Example C, in which the mixture of lysine and galactose was heated, also showed a peak around 325 nm, similarly to Example. These indicate that melanoidin is generated by a Maillard reaction between lysine and galactose in Reference Example C, and melanoidin is also generated in Example A by a Maillard reaction caused by sugars, amino acids, peptides, and other substances present in the pressed lees, as inferred from Tables 1 and 2.

### Example 4

Each of the resulting koji-containing food product and the sample prior to the heating and drying step was placed directly on a sample stand and analyzed for FT-IR spectrum (measuring instrument: IRAffinity-IS spectrometer, available from Shimadzu Corporation). The results are shown in FIGS. 4A and 4B.

In the fingerprint region (1500 cm⁻¹ to 650 cm⁻¹), in which a substance-specific spectrum tends to appear, the koji-containing food product of the present invention has an increased number of peaks. This indicates that sugars, amino acids, peptides, etc. present in the pressed lees undergo Maillard reactions during the heating and drying step, resulting in generation of many substances including melanoidin.

### Example 5

### <Sensory Evaluation>

Sensory evaluation was conducted by trained expert panelists (hereafter referred to as “panelists”) for each of the following foods, comparing the food with the koji-containing food product added thereto (Example) and the food having the same composition but without the koji-containing food product being added thereto (Control).

### (5-1) Butter Cookies

Butter cookies (Control) made by baking the ingredients of the following composition at 170° C. for 10 minutes, and butter cookies (Example) made in the same manner but with the addition of 37.5 g of the koji-containing food product of the present invention were prepared. Sensory evaluation of these samples was conducted by ten panelists.

### —Butter Cookies Ingredients—

Flour: 250 g
Unsalted butter: 100 g
Soft brown sugar: 100 g
Whole egg: 1

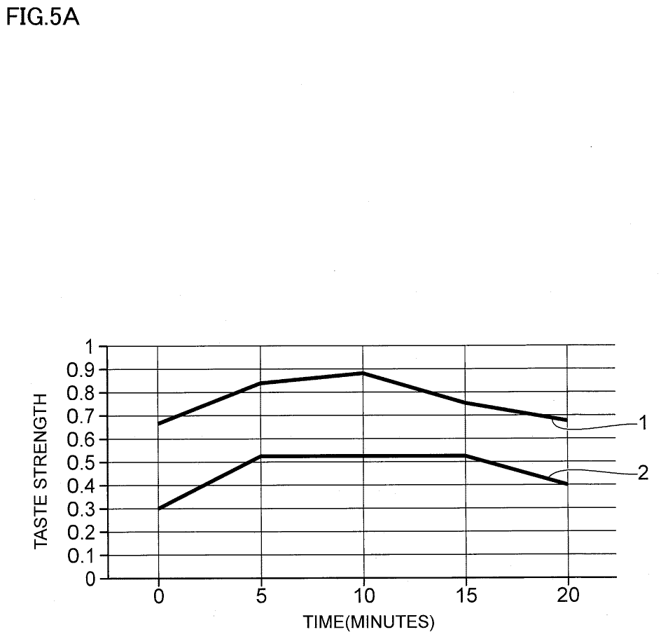

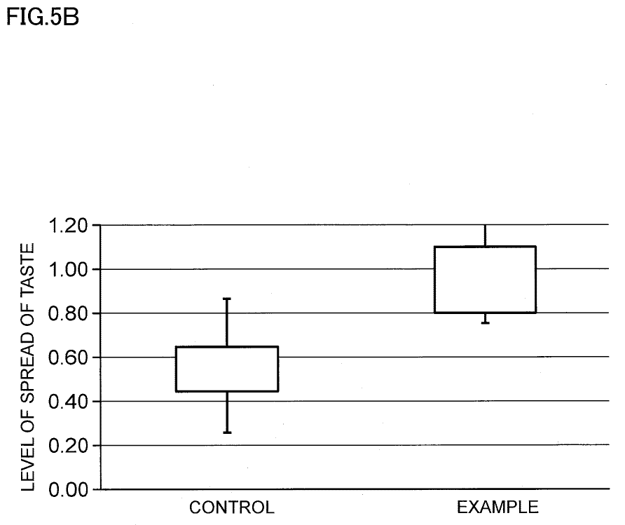

Changes in taste strength were evaluated on an absolute 0 (weakest)-to-1 (strongest) scale at 0 seconds, 5 seconds, 10 seconds, 15 seconds, and 20 seconds after the food was put in the mouth, and an average of the scores by the ten panelists was taken at each time point. The results are shown in the temporal change graph of FIG. 5A. At all of the time points, the taste was felt more strongly in Example 1 than in Control 2. Also, the spread of taste in the mouth was evaluated on an absolute 0 (weakest)-to-1.2 (strongest) scale, and an average of the scores by the panelists was taken. The results are shown in FIG. 5B, which indicate that the spread of taste in the mouth was more pronounced in Example.

### (5-2) Potato Chips

A seasoning (Control) made from the following ingredients and a seasoning (Example) made from the same ingredients except for using 7.2 parts of dextrin and 45 parts of the koji-containing food product of the present invention instead of 52.2 parts of dextrin were prepared.

### —Seasoning Ingredients—

Anhydrous crystalline glucose: 40 parts
Butter flavor: 1 part
Soy sauce flavor: 1 part
Roasted soy sauce flavor: 1 part
Silicon dioxide powder: 0.8 parts
Potato starch: 4 parts
Dextrin: 52.2 parts

Commercially available, lightly salted potato chips were purchased, and as much seasoning powder (such as salt) on the surfaces of the chips as possible was removed using a brush. Then, the potato chips and the seasoning (Example or Control) were mixed in the ratio of 92:8, and sensory evaluation of these samples was conducted by thirteen panelists.

A paired comparison test was used for the sensory evaluation. The panelists were asked to put each of the samples into his/her mouth and swallow it and to choose the sample that he/she found to have a stronger richness. The number of panelists who chose each sample is shown in Table 4.

### (5-3) Salted Cod Roe

Commercially available salted cod roe was purchased, and the cod roe skin was removed to only use the egg part. The koji-containing food product of the present invention in an amount accounting for 0.5% was added to and mixed with salted cod roe, and the resultant sample was compared with salted cod roe without the koji-containing food product added thereto (Control).

Sensory evaluation was conducted by thirteen panelists, using a paired comparison test. The panelists were asked to put each of the samples into his/her mouth and swallow it and to choose the sample that he/she found to have a stronger umami taste and richness. The number of panelists who chose each sample is shown in Table 4.

### (5-4) Miso Ramen Soup

Miso ramen soup (Control) was compared with miso ramen soup (Example) containing 0.25% of the koji-containing food product of the present invention.

Sensory evaluation was conducted by thirteen panelists, using a paired comparison test. The panelists were asked to put each of the samples into his/her mouth and swallow it and to choose the sample that he/she found to have a stronger umami taste and richness. The number of panelists who chose each sample is shown in Table 4.

### (5-5) Chocolate

150 parts of chocolate (black or white chocolate) were melted over hot water and mixed with 100 parts of feuillantine chocolate and 1.5 parts of the koji-containing food product of the present invention, followed by refrigerating the mixture chocolate into a round shape to prepare feuillantine chocolate. Meanwhile, feuillantine chocolate (Control) was prepared in the same manner, except that it was not mixed with the koji-containing food product of the present invention. These samples were then subjected to sensory evaluation.

Sensory evaluation was conducted by thirteen panelists, using a paired comparison test. The panelists were asked to put each of the samples into his/her mouth and swallow it and to choose the sample that he/she found to have a stronger umami taste and richness. The number of panelists who chose each sample for black and white chocolate is shown in Table 4.

### (5-6) Japanese Omelette

An egg mixture of the following ingredients was poured into a mold and baked in a steam convection oven at 160° C. for 30 minutes to obtain a Japanese omelette (Control).

### —Japanese Omelette Ingredients—

Chicken eggs: 10
Bonito broth: 150 mL
Mirin (sweet sake): 27 mL
Sake: 40 mL
Dashi broth: 27 mL

A Japanese omelette (Example) was made in the same manner, except that 7.5 g of the koji-containing food product of the present invention was further added.

These Japanese omelettes of Example and control were subjected to sensory evaluation. The sensory evaluation was conducted by eight panelists, using a paired comparison test. The panelists were asked to put each of the samples into his/her mouth and swallow it and to choose the sample that he/she found to have a stronger umami taste and richness. The number of panelists who chose each sample is shown in Table 4.

### (5-7) White Sauce

A white sauce (Control) was prepared by simmering the following ingredients. A white sauce (Example) was prepared in the same manner, except that 9 parts of the koji-containing food product of the present invention was further added in addition to the following ingredients.

### —White Sauce Ingredients—

Chicken breast meat: 300 parts
Liquid shio-koji (available from Hanamaruki Foods Inc.): 15 parts
White sauce: 300 parts
Milk: 150 parts
Salt: 2.4 parts
Onion: 200 parts
Shimeji mushrooms: 100 parts
Unsalted butter: 15 parts

These white sauces of Example and Control were subjected to sensory evaluation. The sensory evaluation was conducted by eight panelists, using a paired comparison test. The panelists were asked to put each of the samples into his/her mouth and swallow it and to choose the sample that he/she found to have a stronger umami taste and richness. The number of panelists who chose each sample is shown in Table 4.

### (5-8) Scones

Scones (Control) were made using the following ingredients. Scones (Example) were also made in the same manner, except that 12 g of the koji-containing food product of the present invention was added in addition to the following ingredients.

The scones were made as follows. Flour, baking powder, sugar, salt, and the koji-containing food product (if used) were mixed together, followed by adding butter to the mixture and rubbing it until it resembles breadcrumbs. Meanwhile, beaten chicken eggs were mixed with milk, which was then lightly mixed with the flour, etc. mixed earlier. And the resulting mixture was shaped and baked in an oven at 180° C. for 15 minutes to make scones.

### —Scone Ingredients—

Flour: 200 g
Baking powder: 8 g
Sugar: 30 g
Butter: 70 g
Chicken egg: 1
Milk: 50 g
Salt: 1 g

These scones of Example and Control were subjected to sensory evaluation. The sensory evaluation was conducted by eight panelists, using a paired comparison test. The panelists were asked to put each of the samples into his/her mouth and swallow it and to choose the sample that he/she found to have a stronger umami taste and richness. The number of panelists who chose each sample is shown in Table 4.

TABLE 4

| | Food | | | | | | | |
|---|---|---|---|---|---|---|---|---|
| | Potato | Salted cod | Miso ramen | Black | White | Japanese | White | |
| | chips | roe | soup | chocolate | chocolate | omelette | sauce | Scones |
| | Evaluation | | | | | | | |
| | | Strong | Strong | Strong | Strong | Strong | Strong | Strong |
| | Strong | umami taste | umami taste | umami taste | umami taste | umami taste | umami taste | umami taste |
| | richness | and richness | and richness | and richness | and richness | and richness | and richness | and richness |
| Koji-containing | 10 | 10 | 10 | 9 | 9 | 8 | 7 | 7 |
| food product | | | | | | | | |
| Control | 3 | 3 | 3 | 1 | 1 | 0 | 1 | 1 |
| Total no. of | 13 | 13 | 13 | 10 | 10 | 8 | 8 | 8 |
| panelists | | | | | | | | |

For each of the foods, the significantly higher number of panelists answered that the sample using the koji-containing food product of the present invention had stronger richness, etc.

### <Sensory Evaluation>

The following are the descriptive answers in the sensory evaluation of each food, shown in comparison between Examples of the present invention and Controls.

### (5-2) Potato Chips

### Example

The initial taste (saltiness) is mild.
The butteriness (milkiness) is enhanced.
The umami taste lingers.

### Control

The salty flavor is more prominent.
The butteriness (milkiness) is not so high.

### (5-3) Salted Cod Roe

### Example

The middle to aftertaste is strong.
The saltiness is mild.

### Control

The saltiness is strong.

### (5-4) Miso Ramen Soup

### Example

The initial taste (saltiness) is mild.
The middle to aftertaste is stronger, with the umami taste lingering in the aftertaste.

### Control

The saltiness comes first, and the subsequent flavor soon disappeared.

### (5-5) Chocolate

### —White Chocolate—

### Example

Milkiness is enhanced.
The middle taste is enhanced.

### Control

Milkiness comes first, and soon disappears.

### —Black Chocolate—

### Example

The bitterness is masked.
The richness of the fats and oils is enhanced.
The middle to aftertaste is enhanced.

### Control

The bitterness is more prominent.
Richness is not so high.

### (5-6) Japanese Omelette

### Example

The aftertaste is persistent.
The brothy flavor is strong.

### Control

The brothy flavor can be felt with the egg flavor, but it disappears quickly.

### (5-7) White Sauce

### Example

· The milkiness is enhanced.
The butteriness is enhanced.

### Control

The saltiness is more prominent.
Flavor is not strong.

### (5-8) Scones

### Example

The butteriness is enhanced.
The texture is crispy.

### Control

Flavor is not strong.
The texture is crumbly.

### Example 6

The koji-containing food product obtained in Example 1 had a lighter brown or ochre color than the pressed lees when heated, and gave richness, umami taste, and other attributes to each food as shown in Example 5.

Instead of the heating at 105° C. for 2 hours performed in Example 1, the heating under the following temperature and time conditions was performed to evaluate the resulting powders, based on the colors of the respective powders.
At 70° C. for 1 hour: Almost no change in color was observed before and after heating.
At 80° C. for 30 minutes: Color change was slightly less than in Example 1.
At 100° C. for 1 hour: Color change similar to Example 1 was observed.
At 120° C. for 1 hour: The color was slightly more reddish than in Example 1.
At 140° C. for 30 minutes: The color was more reddish than in Example 1, and there was a faint burnt smell.

### Example 7

### <Sensory Evaluation: Reduction of the Sharpness of Salt>

The following sensory evaluation was conducted by panelists to investigate the effect of the koji-containing food product of the present invention in reducing the sharpness of salt (a salty taste that directly tingles the tongue).

### (7-1) Salt Solution

A 1.0% (w/v, mass to volume percentage) salt solution (Control) was prepared, and a salt solution with a concentration of 0.2% (w/v) of the koji-containing food product was also prepared by adding the koji-containing food product obtained in Example 1 to the above salt solution (Example; 2 g of the koji-containing food product was contained 1 L of the salt solution). The salt solutions were subjected to sensory evaluation. The sensory evaluation was conducted by eleven panelists. The panelists were asked to put each of the salt solutions of Control and Example into his/her mouth and swallow it and to evaluate the saltiness on the following 1-to-5 scale, and an average of the scores by the panelists was taken.

### Saltiness Evaluation: Weak 1 2 3 4 5 Strong

The evaluation results are as follows. The koji-containing food product of the present invention was found to have a statistically significant (p<0.01) effect of reducing the sharpness of salt.

### Evaluation Results: Average of Scores by the Eleven Panelists

Control: 3.8
Example: 2.6

### (7-2) Anchovy Sauce

A commercially available anchovy sauce (Control) was prepared, and an anchovy sauce (Example) was also prepared by adding the koji-containing food product obtained in Example 1 to this commercially available anchovy sauce so as to give a 0.5 wt. % concentration of the koji-containing food product. These anchovy sauces were subjected to sensory evaluation. The sensory evaluation was conducted by eleven panelists. The panelists were asked to put each of the anchovy sauces of Control and Example into his/her mouth and swallow it and to choose, in a paired comparison manner, the one that he/she found to have stronger saltiness. The evaluation results are as follows. The koji-containing food product was found to have a statistically significant (p<0.05) effect of reducing the sharpness of salt.

### Evaluation Results: The Number of Panelists Who Chose Each Sample

Control: 9
Example: 2

### Example 8

### <Sensory Evaluation: Persistence of Spiciness>

The following sensory evaluation was conducted by panelists on the koji-containing food product of the present invention to investigate its effect on the persistence of spiciness.

### (8-1) Chili Pepper Solution

A chili pepper solution (Control) containing 0.3% (w/v, mass to volume percentage) of a chili pepper extract was prepared by extracting it with water. A chili pepper solution (Example) was also prepared by adding the koji-containing food product obtained in Example 1 to the above chili pepper solution so as to give a 0.3% (w/v) concentration of the koji-containing food product. The pepper solutions were subjected to sensory evaluation. The sensory evaluation was conducted by eleven panelists. The panelists were asked to put each of the pepper solutions of Control and Example into his/her mouth and swallow it and to evaluate the persistence of spiciness on the following 1-to-5 scale, and an average of the scores by the panelists was taken.

### Persistence of Spiciness: Short 1 2 3 4 5 Long

The evaluation results are as follows. The koji-containing food product of the present invention was found to have a statistically significant (p<0.01) effect of lengthening the spiciness.

### Evaluation Results: Average of Scores by the Eleven Panelists

Control: 3.2
Example: 4.3

### (8-2) Curry

A commercially available curry roux (Control) was prepared. A curry roux (Example) was also prepared by adding the koji-containing food product obtained in Example 1 to the above curry roux so as to give a 0.3 wt. % concentration of the koji-containing food product. These curry roux were subjected to sensory evaluation. The sensory evaluation was conducted by seven panelists. The panelists were asked to put each of the curry roux of Control and Example into his/her mouth and swallow it and to choose, in a paired comparison manner, the one that he/she found to have a longer-lasting spiciness. The evaluation results are as follows. The koji-containing food product of the present invention was found to have a statistically significant (p<0.01) effect of lengthening the spiciness.

### Evaluation Results: The Number of Panelists Who Chose Each Sample

Control: 0
Example: 7

### Example 9

The koji-containing food products of the second and third embodiments were prepared according to the steps shown in FIG. 6. However, the classifying step was omitted.

### (1) Koji-Containing Food Product of the Second Embodiment

The rice koji obtained in process (1) of Example 1 was heated at 105° C. for 2 hours using a steam convection (SelfCookingCenter XS, available from Rational AG) and dried. The heated rice koji was pulverized by a milling machine to obtain the desired koji-containing food product in a powder form.

From 1.0 kg of the rice koji, 0.78 kg of the koji-containing food product of the second embodiment was obtained.

### (2) Koji-Containing Food Product of the Third Embodiment

The rice koji obtained in process (1) of Example 1 was preheated at 60° C. for 6 hours using a thermostatic chamber (SH-221, available from Espec Corporation) and then heated at 105° C. for 2 hours using a steam convection (SelfCookingCenter XS, available from Rational AG) and dried. The heated rice koji was pulverized by a milling machine to obtain the desired koji-containing food product in a powder form.

From 1.0 kg of the rice koji, 0.85 kg of the koji-containing food product of the third embodiment was obtained. The nutrition facts (theoretical values per 100 g) of the resulting koji-containing food products of the second and third embodiments as a food product are shown in Table 5.

TABLE 5
Nutrition facts (per 100 g)

| | Koji-containing food | Koji-containing food |
|---|---|---|
| | product of the | product of the |
| | second embodiment | third embodiment |
| Calories | 385 kcal | 373 kcal |
| Water | 5.7 g | 8.0 g |
| Protein | 7.6 g | 7.4 g |
| Lipid | 1.9 g | 1.4 g |
| Carbohydrates | 84.3 g | 82.8 g |
| Ash | 0.5 g | 0.4 g |
| Sodium | 0.01 g | 0.01 g |
| chloride | | |
| equivalent | | |

### Example 10

### <Sensory Evaluation: Persistence of Umami Taste>

To investigate the effect of the koji-containing food products of the second and third embodiments on the persistence of umami taste, sensory evaluation of the following consommé soups was conducted by panelists.

A commercially available consommé soup (Control) was prepared, and a consommé soup (Example) was also prepared by adding the koji-containing food product of the second or third embodiment to the above soup so as to give a 1.0 wt. % concentration of the koji-containing food product. These soups were subjected to sensory evaluation. The sensory evaluation was conducted by nine panelists. The panelists were asked to put each of the consommé soups of Control and Example into his/her mouth and swallow it and to choose, in a paired comparison manner, the one that he/she found to have a longer-lasting umami taste. The evaluation results are as follows. The koji-containing food product of the third embodiment was found to have a statistically significant (p<0.05) effect of lengthening the umami taste. On the other hand, while the koji-containing food product of the second embodiment got six votes from the panelists, which was higher than three votes to Control, no statistically significant difference was confirmed.

### Evaluation Results: The Number of Panelists Who Chose Each Sample

### Koji-Containing Food Product of the Second Embodiment

Control: 3
Example: 6
   Koji-Containing Food Product of the Third Embodiment (p<0.05)
Control: 1
Example: 8

### Example 11

### <Sensory Evaluation: Persistence of Spiciness>

Sensory evaluation was conducted by panelists on the following chili pepper extract solutions to investigate the effect of the koji-containing food product of the third embodiment on the persistence of spiciness.

A chili pepper extract solution (Control; 0.3 wt. % concentration of chili pepper extracts in water) was prepared, and a chili pepper extract solution (Example) was also prepared by adding the koji-containing food product of the third embodiment to the above extract solution so as to give a 1.0 wt. % concentration of the koji-containing food product. These extract solutions were subjected to sensory evaluation. The sensory evaluation was conducted by nine panelists. The panelists were asked to put each of the consommé soups of Control and Example into his/her mouth and swallow it and to choose, in a paired comparison manner, the one that he/she found to have a longer-lasting spiciness. The evaluation results are as follows. The koji-containing food product of the third embodiment was found to have a statistically significant (p<0.05) effect of lengthening the umami taste.

### Evaluation Results: The Number of Panelists Who Chose Each Sample

Control: 1
Example: 8

### Example 12

The substances in the koji-containing food product of the present invention were examined.

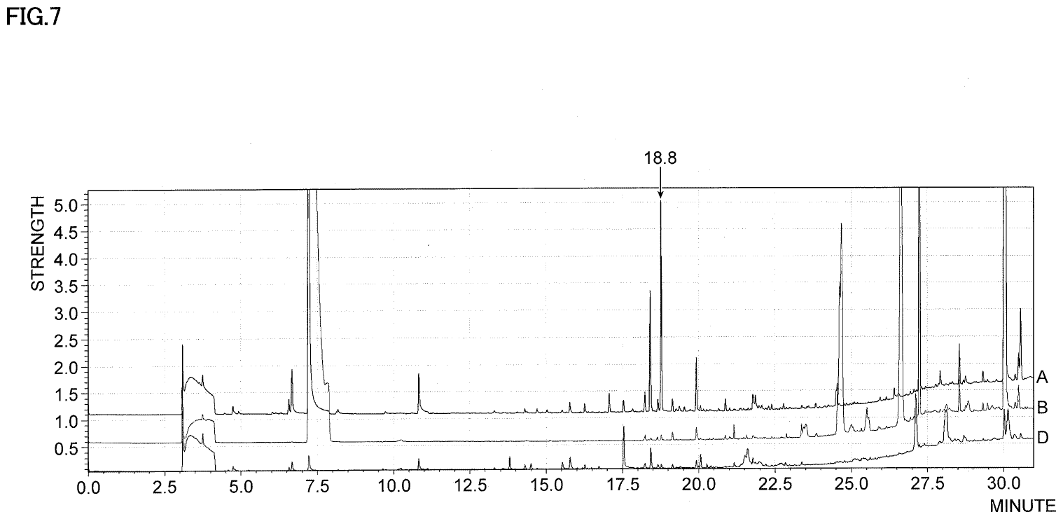

First, the koji-containing food product, the sample prior to the heating and drying step, and the rice koji were qualitatively analyzed using a gas chromatography-mass spectrometer (GCMS-QP2010 Ultra, available from Shimadzu Corporation). The analytical conditions were as follows, and the resulting graph is shown in FIG. 7. In the graph, chart A represents the sample of the koji-containing food product of the first embodiment obtained in process (1) in Example 1, chart B represents the sample of pressed lees (prior to heating and drying the koji-containing food product) obtained in process (2) in Example 1 (comparative example), and chart D represents the sample of rice koji obtained in process (1) in Example 1.

### <Analytical Conditions>

Solid-phase microextraction (SPME)
   SPME fiber: 65 μm Stable Flex PDMS/DVB (Supelco 57293-U, available from Merck Life Sciences)
   Incubation time: 10 minutes
   Oven: 105° C.
   SPME adsorption time: 5 minutes
   Desorption time: 1 minute
Gas chromatography
   Column oven: maintained at 40° C. for 5 minutes. Then the temperature is increased by 8° C. per minute to 220° C. and maintained at 220° C. for 5 minutes.
   Vaporization chamber temperature: 250° C.
   Column: ZB-WAX-PLUS (60 m, 0.25 mm I.D., df=0.25 m)
   Carrier gas: helium
   Carrier gas control: constant linear velocity, 31.2 cm/see
   Injection mode: split
Mass spectrometry
   Interface: 230° C.
   Ion source: 220° C.
   Measurement mode: scan
   Mass range: m/z 20-400
   Event time: 0.3 seconds

The peak at a retention time of 18.8 minutes in chart A is not present in charts B and D. This peak was identified as 3-furaldehyde with the aid of a search DB: MIST 11 Mass Spectral Library.

Then, quantification of 3-furaldehyde contained in the koji-containing food products of the first to third embodiments, in the sample prior to the heating and drying step (pressed lees obtained in process (2) in Example 1), and in the rice koji obtained in process (1) in Example 1 was performed using headspace-gas chromatography-mass spectrometry. A 2 g of each sample was weighed out into a 20 mL vial container and analyzed under the following analytical conditions.

### <Analytical Conditions>

Headspace
   Auto injector: AOC-5000
   Syringe heater: MSH 02-00B
   Syringe size: 2.5 mL
   Injection volume: 1.0 mL
   Incubation time: 20 minutes
   Oven: 80° C.
   Syringe needle temperature: 80° C.
Gas chromatography and mass spectrometry

The aforementioned gas chromatography-mass spectrometer (GCMS-QP2010 Ultra, available from Shimadzu Corporation) was employed under the same analytical conditions.

The amount of 3-furaldehyde contained in each sample is shown in Table 6.

TABLE 6

| | 3-Furaldehyde |
|---|---|
| | content (ng/g) |
| Koji-containing food product | 47 |
| of the first embodiment | |
| Koji-containing food product | 21 |
| of the second embodiment | |
| Koji-containing food product | 26 |
| of the third embodiment | |
| Prior to heating and | <5 |
| drying step | |
| Rice koji | <5 |

In the table, the value “<5” indicates below limit of detection (5 ng/g), meaning that no 3-furaldehyde was detected.

Similarly, no 3-furaldehyde was detected from any of rice koji-containing food products, including commercially available powdered koji.

By nature of its structure, 3-Furaldehyde is believed to be contained as an intermediate product of melanoidin generated by a Maillard reaction, and is believed to be one of the umami and richness enhancers for koji-containing food products.

### Example 13

A high-performance liquid chromatography (HPLC) analysis was performed on the koji-containing food product of the present application using a Nexera system (available from Shimadzu Corporation) to identify the substances contained in it.

The HPLC analysis was performed on the koji-containing food product of the first embodiment obtained in process (1) in Example 1, under the following conditions.

### <HPLC Analysis Conditions>

Extract solution: extracted with water four times the weight of the analyte
Mobile phase A: 0.1 wt. % trifluoroacetic acid solution
Mobile phase B: acetonitrile
Isocratic conditions: mobile phase A 95%, mobile phase B 5%
Flow rate: 0.6 mL/min
Column: CAPCELL PAK C18 AQ (available from Osaka Soda Co., Ltd., 4.6 mm×100 mm, 3 μm)
Detection wavelength: 297 nm

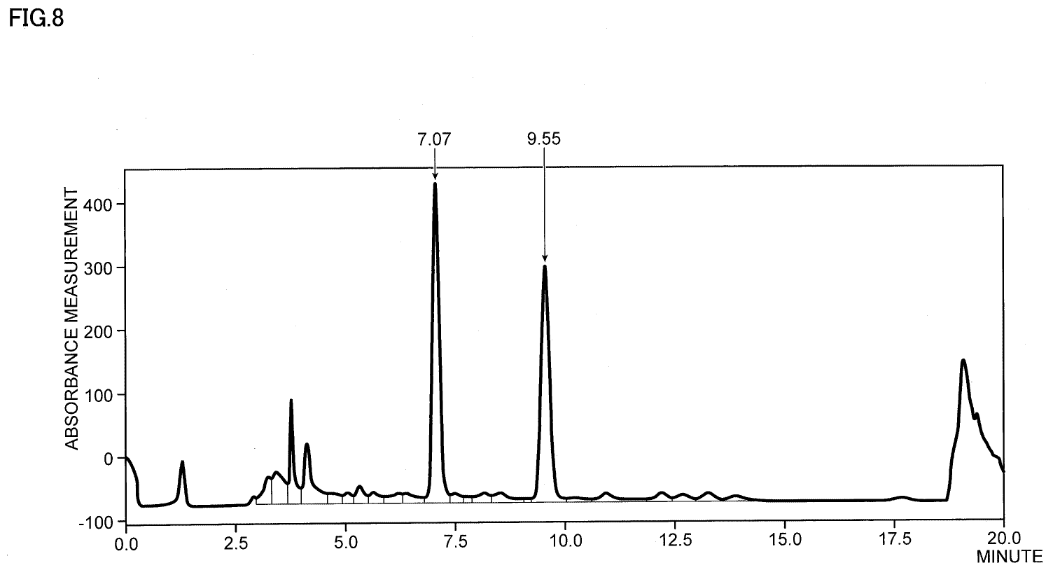

The resulting chromatograph is shown in FIG. 8. As shown in FIG. 8, two characteristic peaks are present at retention times of 7.07 minutes (peak A) and 9.55 minutes (peak B). The koji-containing food products of the second and third embodiments also have two similar peaks as shown below.

### <Peak Positions: Retention Time>

The koji-containing food product of the second embodiment: 7.06 minutes and 9.56 minutes
The koji-containing food product of the third embodiment: 7.03 minutes and 9.50 minutes

### (1) Peak A

As shown below, peak A is a reaction product of the Maillard reaction between cysteine and glucose. A control Maillard reaction product was obtained by heating 1 mole of cysteine, 2 moles of glucose, and 0.2 moles of sodium bicarbonate at 105° C. for 2 hours.

An HPLC analysis, UV spectral comparison, and an LC-MS analysis were performed on the koji-containing food product and the Maillard reaction product of cysteine and glucose.

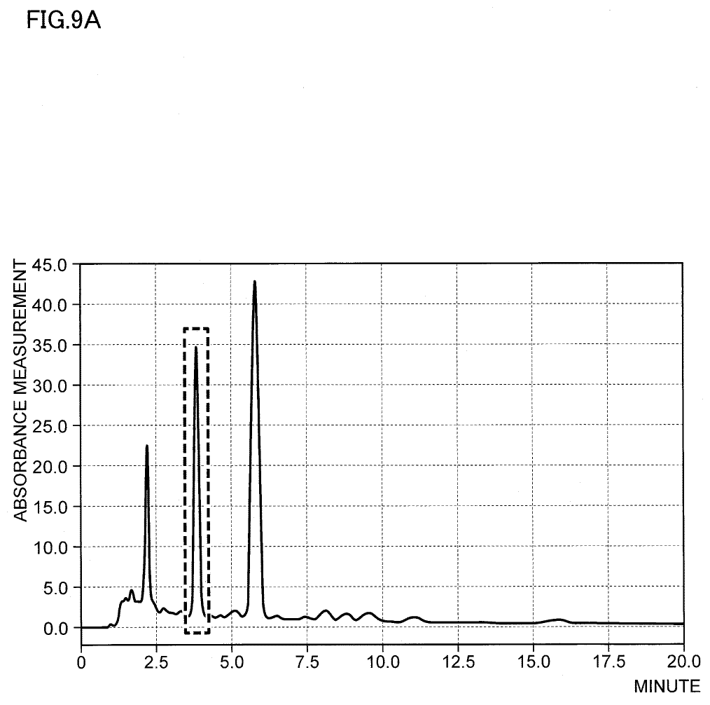

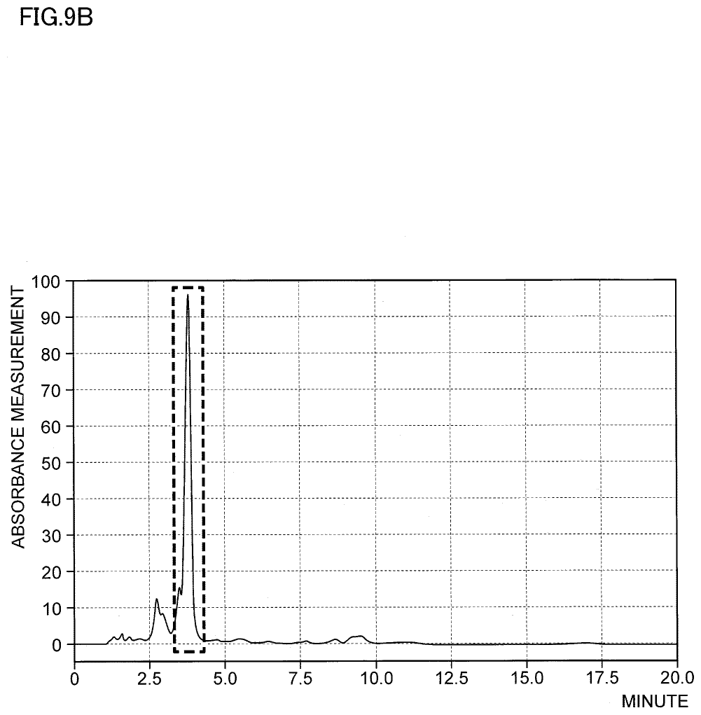

The koji-containing food product of the first embodiment was used as the koji-containing food product, and a water-extracted liquid of the koji-containing food product was adsorbed on an ODS column (a column for reversed-phase chromatography filled with a filler in which octadecylsilyl groups are chemically bonded to a silica gel carrier) and then eluted with a 10% concentration ethanol solution to prepare a sample. The Maillard reaction product of cysteine and glucose was adsorbed on an ODS column and then eluted with a 10% concentration ethanol solution to prepare a sample. These samples were subjected to the HPLC analysis under the same conditions. The HPLC analysis results are shown in FIGS. 9A and 9B. FIG. 9A is an HPLC graph of the koji-containing food product, while FIG. 9B is an HPLC graph of the Maillard reaction product of cysteine and glucose. Both graphs have a peak (enclosed by dotted lines) at almost the same retention time of about 3.9 minutes.

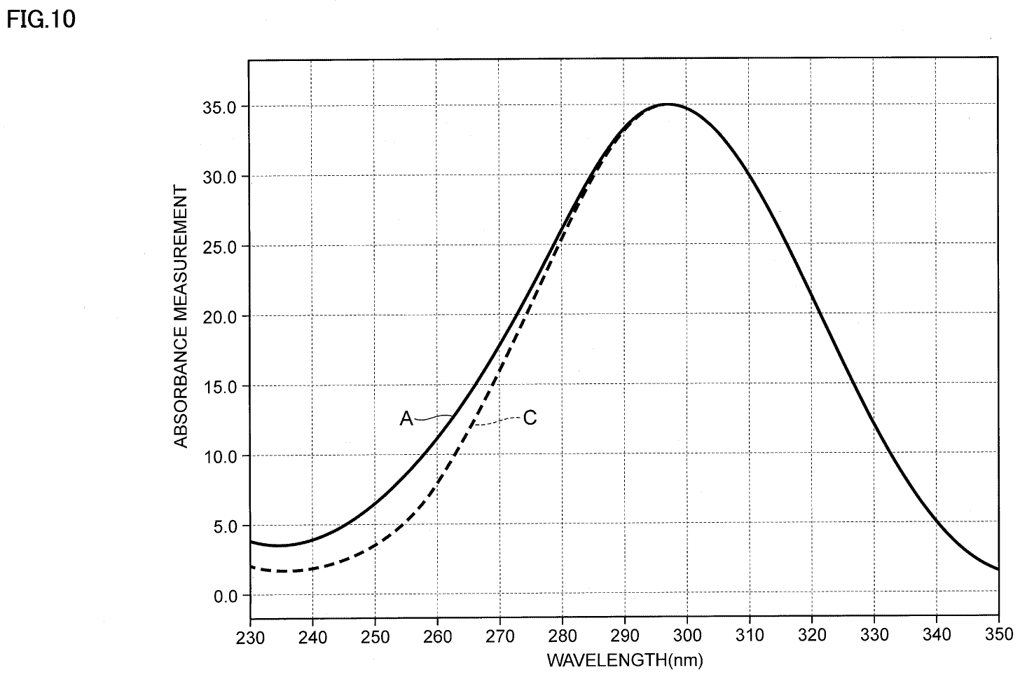

FIG. 10 shows superimposed UV spectra of the components in the two samples corresponding to the aforementioned peaks at the retention time of about 3.9 minutes. Chart A is the spectrum of the peak in the koji-containing food product, and chart C is the spectrum of the peak in the Maillard reaction product of cysteine and glucose. As can be seen from the UV spectra of FIG. 10, the components from the two samples had the same maximum absorption wavelength at 297 nm.

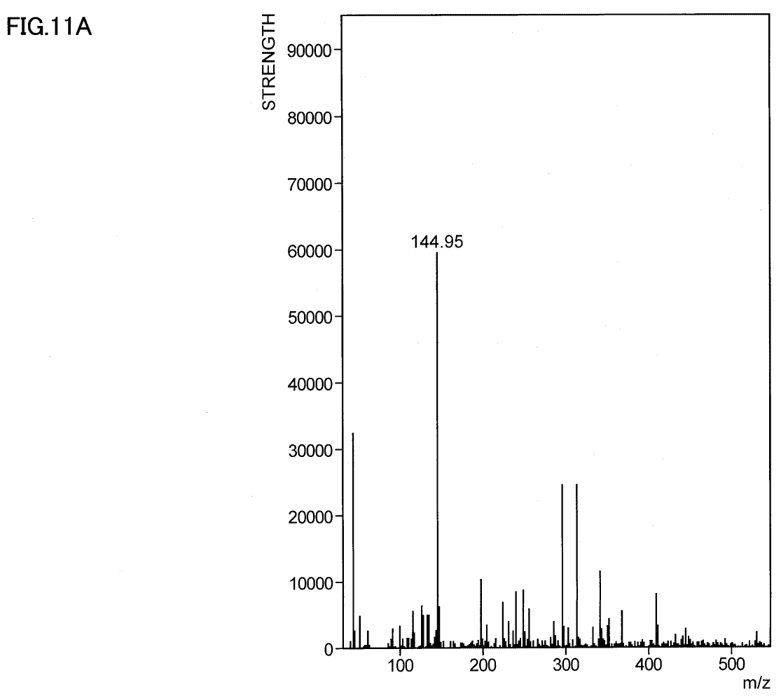

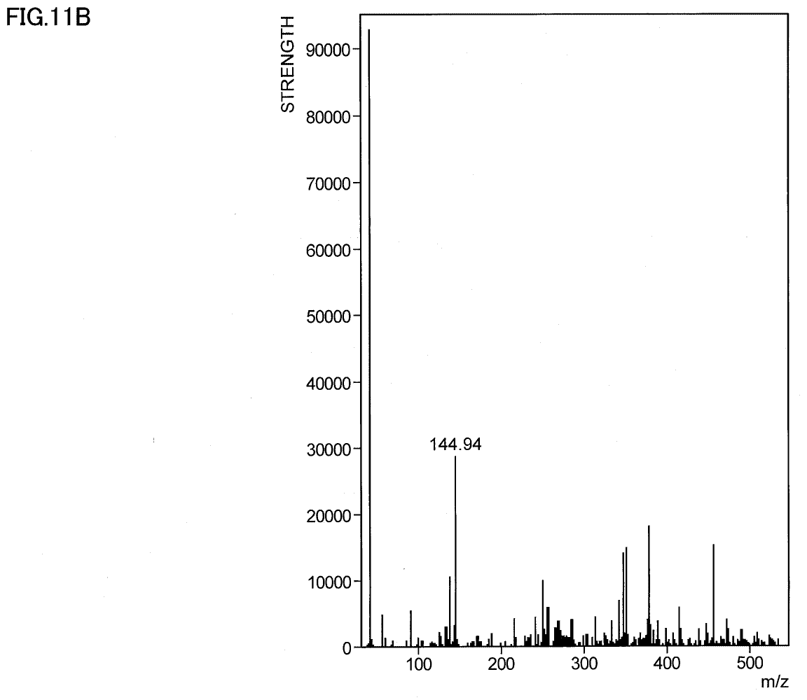

FIG. 11 shows mass spectra of the components in the two samples corresponding to the aforementioned peaks, as measured in the positive ion mode of ESI-MS using an LC-MS method. FIG. 11A shows a mass spectrum of the koji-containing food product of the first embodiment, while FIG. 11B shows a mass spectrum of the Maillard reaction product of cysteine and glucose. Both mass spectra have a peak around m/z 144.9.

The above demonstrates that the koji-containing food products of the first to third embodiments contain the Maillard reaction product of cysteine and glucose.

A Nexera system (available from Shimadzu Corporation) was used in the analyses shown in FIGS. 9 and 10, and the conditions for the HPLC analysis shown in FIG. 9 were as follows. The mass spectra shown in FIGS. 11A and 11B were obtained by performing mass spectrometry on peaks corresponding to the peaks shown in FIG. 10, using a Waters Alliance system (available from Nihon Waters K.K.) with a QDa detector connected thereto. The LC-MS analysis conditions were as follows.

### <HPLC Analysis Conditions>

Mobile phase A: 0.1 wt. % trifluoroacetic acid solution
Mobile phase B: acetonitrile
Isocratic conditions: mobile phase A 95%, mobile phase B 5%
Flow rate: 1.0 mL/min
Column: CAPCELL PAK C18 MGII (available from Osaka Soda Co., Ltd., 4.6 mm×100 mm, 3 μm)
Detection wavelength: 297 nm

### <LC-MS Analysis Conditions>

Mobile phase A: 0.1% formic acid
Mobile phase B: acetonitrile (containing 0.1% formic acid)
Isocratic conditions: mobile phase A 95%, mobile phase B 5%
Flow rate: 1.0 mL/min
Column: CORTECS C18 (available from Nihon Waters K.K., 4.6 mm×150 mm, 2.7 μm)
Detector: QDa (scan range m/z 30 to 1250)

### (2) Peak B

Table 7 lists the retention time of peak B in the HPLC analysis, the relative ratio of the retention time of peak B to peak A (retention time of peak B/retention time of peak A), and the maximum absorption wavelength in the UV spectrum for the koji-containing food products of the first to third embodiments. From these results, peak B is considered to be the same compound in all koji-containing food products.

TABLE 7

| | | Peak B | UV maximum |
|---|---|---|---|
| | Peak B | retention | absorption |
| Koji-containing | retention | time/Peak A | wavelength |
| food product | time (min) | retention time | (nm) |
| Koji-containing food | 9.55 | 1.35 | 284 |
| product of the first | | | |
| embodiment | | | |
| Koji-containing food | 9.56 | 1.36 | 285 |
| product of the second | | | |
| embodiment | | | |
| Koji-containing food | 9.50 | 1.35 | 285 |
| product of the third | | | |
| embodiment | | | |

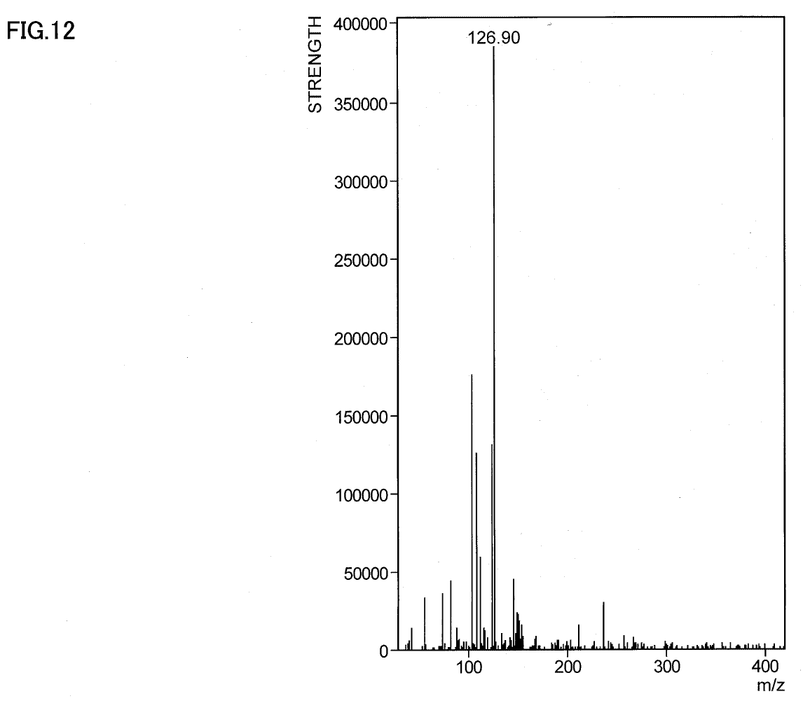

Further, a mass spectrum measured in the positive ion mode of ESI-MS using an LC-MS method is shown in FIG. 12. Each analysis for peak B was carried out in the same way as for peak A.

### REFERENCE SIGNS LIST

A Example
B Prior to heating
C Reference example
1 Example
2 Control

1. A method for producing a koji-containing food product, comprising steps of:
fermenting a mixture containing rice, a koji mold, and water;
separating the mixture into solids and liquids; and
heating the solids obtained by the separation.

2. The method for producing a koji-containing food product according to claim 1, comprising heating the solids at a temperature greater than or equal to 80° C. and less than or equal to 140° C.

3. The method for producing a koji-containing food product according to claim 1, comprising heating the solids for greater than or equal to 30 minutes and less than or equal to 5 hours.

4. The method for producing a koji-containing food product according to claim 1, comprising fermenting the mixture with salt added thereto in the fermenting step.

5. The method for producing a koji-containing food product according to claim 4, comprising fermenting the mixture at a temperature greater than or equal to 4° C. and less than or equal to 40° C.

6. The method for producing a koji-containing food product according to claim 4, wherein the mixture contains rice koji, which is obtained by propagating a koji mold on steamed rice, and water.

7. The method for producing a koji-containing food product according to claim 1, comprising fermenting the mixture with ethanol further added thereto.

8. A method for producing a koji-containing food product, comprising a step of heating rice koji, which is obtained by propagating a koji mold on steamed rice, wherein
the koji-containing food product contains 3-furaldehyde.

9. The method for producing a koji-containing food product according to claim 8, comprising heating the rice koji at a temperature greater than or equal to 80° C. and less than or equal to 140° C.

10. The method for producing a koji-containing food product according to claim 8, comprising heating the rice koji for greater than or equal to 30 minutes and less than or equal to 5 hours.

11. The method for producing a koji-containing food product according to claim 8, comprising preheating the rice koji at a temperature greater than or equal to 50° C. and less than or equal to 75° C., prior to the step of heating the rice koji.

12. The method for producing a koji-containing food product according to claim 11, comprising preheating the rice koji for greater than or equal to 3 hours, prior to the step of heating the rice koji.

13. A dried koji-containing food product comprising:
a decomposition product of rice fermentation by a koji mold; and
a deactivated koji mold.

14. The koji-containing food product according to claim 13, wherein the koji-containing food product further contains salt.

15. The koji-containing food product according to claim 13, wherein the koji-containing food product contains 3-furaldehyde.

16. The koji-containing food product according to claim 13, wherein a peak A corresponding to a Maillard reaction product of cysteine and glucose is detected in an HPLC analysis and an LC-MS analysis of the koji-containing food product.

17. The koji-containing food product according to claim 16, wherein the koji-containing food product has:
(1) a peak B in a relative retention time range of 1.1 to 1.6 when a retention time of the peak A is taken as 1.0 in chromatography under the following HPLC analysis conditions;
(2) a maximum absorption wavelength of the peak B in a range of 279 nm to 289 nm; and
(3) a peak in an m/z range of 125.9 to 127.9 in mass spectrometry of the peak B in a positive ion mode of ESI-MS,
(HPLC analysis conditions)
Extract solution: extracted with water four times the weight of an analyte
Mobile phase A: 0.1 wt. % trifluoroacetic acid solution
Mobile phase B: acetonitrile
Isocratic conditions: mobile phase A 95%, mobile phase B 5%
Flow rate: 0.6 mL/min
Column: CAPCELL PAK C18 AQ (available from Osaka Soda Co., Ltd., 4.6 mm×100 mm, 3 μm)
Detection wavelength: 297 nm.
